(19) United States
(12) Patent Application Publication
(10) Pub. No.: US 2012/0060161 A1
(43) Pub. Date: Mar. 8, 2012

(54) UI FRAMEWORK DISPLAY SYSTEM AND METHOD

(76) Inventors: Gyong-Jin JOUNG, Yongin-si (KR); Seo-Jin Kim, Hwaseong-si (KR); Hyun-Ki Baik, Seongnam-si (KR); Hee-Jin Chung, Seoul (KR); Jae-Won Kim, Hwaseong-si (KR)

(21) Appl. No.: 13/053,781

(22) Filed: Mar. 22, 2011

(30) Foreign Application Priority Data
Sep. 6, 2010 (KR) 10-2010-0087166

(51) Int. Cl. G06F 9/46

(52) U.S. Cl. 718/102

(57) ABSTRACT

A technique of efficiently improving the processing speed and response time of a user interface (UI) framework in a multi-core environment is provided. According to the technique, it is possible to improve both the throughput and response time of a UI by causing a plurality of workers to process a frame display command.

### CROSS-REFERENCE TO RELATED APPLICATION(S)

This application claims the benefit under 35 U.S.C. §119(a) of Korean Patent Application No. 10-2010-0087166, filed on Sep. 6, 2010, in the Korean Intellectual Property Office, the entire disclosure of which is incorporated herein by reference for all purposes.

### BACKGROUND

1. Field

The following description relates to a technique of effectively improving the processing speed and the responsiveness of a user interface (UI) framework in a multicore environment, and, more particularly, to a UI framework display system, which is capable of improving the throughput of a UI framework and reducing the time taken to perform frame processing, and an operating method of the UI framework display system.

2. Description of the Related Art

In a single core-based user interface (UI) processing method, a UI of an application is processed by a single processor regardless of whether there are other processors available in the system.

In the single core-based UI processing method, preparation, surface allocation, surface drawing, and surface composition are all handled by a single worker.

Preparation involves a measurement process, which is characterized by measuring the size of each element of a frame, and a layout process, which is characterized by laying out where to actually draw each element of the frame. The measurement and layout processes are not performed whenever a frame is output but performed only when necessary.

Once the measurement and layout processes are complete, surface allocation, which is a process of allocating a pixel buffer in which to temporarily enqueue a frame to be displayed, is performed. Thereafter, drawing, which is a process of drawing parts of a frame to be displayed in the pixel buffer by traversing a view hierarchy, i.e., a tree of elements of a frame, is performed. Thereafter, surface composition, which is a process of composing a frame on an actual screen based on the frame parts drawn in the pixel buffer, is performed.

When used in a multi-core environment, however, the single core-based UI processing method cannot provide as excellent UI processing capability as a multi-core-based UI processing method, and may lower general system efficiency and cause inconvenience.

### SUMMARY

The following description relates to a multi-core-based user interface (UI) processing technique suitable for use in a multi-core environment.

The following description also relates to a UI processing technique which employs a fixed-size frame queue and still has excellent UI processing capability.

The following description also relates to a UI processing technique which can vary the size of a frame queue upon the occurrence of a user event and can thus become highly responsive to the user event.

In one general aspect, there is provided a UI framework display system to process a UI framework in a multi-core environment, the UI framework display system including a main thread configured to receive a frame to be displayed in response to an occurrence of a user event from an application and generate at least one command to allow a plurality of cores to divide the frame therebetween and to process the frame together in parallel, a queue configured to enqueue the command therein in consideration of when to display the frame, a worker thread configured to allocate the command to one or more workers and thus to allow the workers to process the command, and a post-worker configured to output a composed frame obtained by the processing of the command.

The command may be a command to divide parts of the frame between the cores and to allow the cores to process their respective parts of the frame in parallel.

The queue may be configured to enqueue one or more commands generated for a single frame therein.

The queue may be configured to enqueue a plurality of commands generated for different frames therein.

The UI framework display system may also include a queue controller configured to adjust the size of the queue, upon the occurrence of a user event, in accordance with information corresponding to the user event.

The queue controller may be configured to be provided with the information corresponding to the user event from an event handling module, which may be provided in the multi-core environment and may receive the user event from a user.

The queue controller may be further configured to reduce the size of the queue in response to the information corresponding to the user event indicating that a gap between a time of the occurrence of a last previous user event and a current user event is less than a threshold time.

The queue controller may be further configured to increase the size of the queue in response to the information corresponding to the user event indicating that a gap between a time of the occurrence of a last previous user event and a current user event is greater than a threshold time.

In another general aspect, there is provided a UI framework display method of processing a UI framework in a multi-core environment, the UI framework display method including receiving information corresponding to a user event, adjusting the size of a queue according to the collected information, receiving a frame to be displayed in connection with the user event from an application and generating a command to divide parts of the frame between a plurality of cores and allow the cores to process their respective parts of the frame in parallel, enqueuing the command in the queue in consideration of when to display the frame, allocating the command to workers of the cores and allowing the workers to process the command, and outputting a composed frame obtained by the processing of the command.

The receiving the information may include receiving the information from an event handling module, which may be provided in the multi-core environment and may receive the user event from a user.

The adjusting the size of the queue may include receiving a time of the occurrence of the user event as the information, comparing a gap between a time of the occurrence of a last previous user event and a current user event with a threshold time, and reducing the size of the queue in response to the gap being less than the threshold time.

The adjusting the size of the queue may also include increasing the size of the queue in response to the gap being greater than the threshold time.

The reducing the size of the queue may include emptying the frame queue by removing one or more commands in the frame queue.

In another general aspect, there is provided a method of displaying a UI framework in a multi-core environment, the method including receiving information regarding a frame to be displayed, causing a plurality of cores to each process portions of the frame in parallel, and outputting a composed frame obtained by the processing by the cores.

The method may further include allocating the portions of the frame to one or more workers provided in the cores.

The method may further include enqueuing commands corresponding to the portions of the frame in a queue.

The method may further include dynamically changing a size of the queue according to timing information corresponding to user events associated with multiple frames.

The size of the queue may be reduced in response to a gap between a last previous user event and a current user event being smaller than a threshold value.

The size of the queue may be increased in response to a gap between a last previous user event and a current user event being larger than a threshold value.

The reducing the size of the queue may include emptying the queue by removing one or more commands in the queue.

Other features and aspects may be apparent from the following detailed description, the drawings, and the claims.

### BRIEF DESCRIPTION OF THE DRAWINGS

FIG. 1 is a diagram illustrating an example of a user interface (UI) framework display system;

FIG. 2 is a detailed diagram illustrating the UI framework display system illustrated in FIG. 1;

FIG. 3 is a diagram illustrating an operation of an example of a UI framework display system;

FIG. 4 is a diagram illustrating an application system including an example of a UI framework display system, which is capable of adjusting the size of a frame queue;

FIG. 5 is a diagram illustrating an operation of another example of a UI framework display system;

FIGS. 6A and 6B are diagrams illustrating an example of how to reduce the size of a frame queue;

FIGS. 7A through 7C are diagrams illustrating an example of how to increase the size of a frame queue;

FIG. 8 is a flowchart illustrating an example of a UI framework display method; and

FIG. 9 is a flowchart illustrating another example of a UI framework display method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

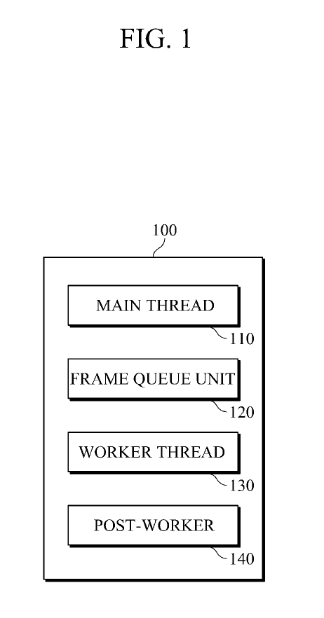

FIG. 1 illustrates an example of a user interface (UI) framework display system. Referring to FIG. 1, a UI framework display system 100 may include a main thread 110, a frame queue unit 120, a worker thread 130, and a post-worker 140.

The main thread 110 may receive frames to be displayed in response to a user event from an application, and may generate one or more commands to allow the frames to be divided and processed by multiple cores.

The frame queue unit 120 may enqueue the commands therein in consideration of the order in which the frames are to be displayed.

The worker thread 130 may allocate the commands to a plurality of workers and thus allow the workers to process the frames in parallel.

The post-worker 140 may output the processed frames.

In short, the processing of frames, e.g., drawing, which is a part of the processing of a UI of an application in a multi-core environment that can be processed in parallel, may be performed in parallel by a plurality of cores. Drawing can be performed in parallel by separate workers, and the number of workers that perform drawing in parallel increases according to the number of cores in a system.

A pixel buffer may be allocated to each worker, which is called surface allocation. Accordingly, each worker may draw parts of a frame to be displayed in the pixel buffer. Thereafter, a frame may be composed on an actual screen based on the frame parts drawn in the pixel buffer, which is called surface composition. Surface allocation and surface composition may be performed by separate modules or may both be performed by the main thread 110.

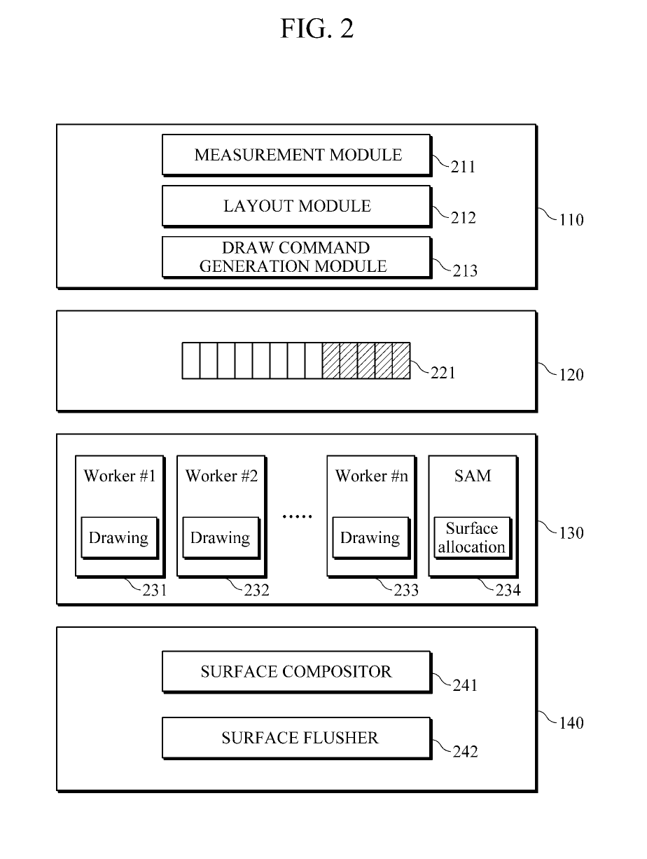

FIG. 2 is a detailed diagram illustrating the UI framework display system illustrated in FIG. 1. Referring to FIG. 2, the main thread 110 may include a measurement module 211, a layout module 212, and a draw command generation module 213. The frame queue unit 120 may include a frame queue 221. The worker thread 130 may include a plurality of workers 231, 232, and 233, which may process frames, and a surface allocation manager (SAM) 234. The post-worker 140 may include a surface compositor 241 and a surface flusher 242.

The measurement and layout modules 211 and 212 may perform measurement and layout processes, respectively, only when necessary. The draw command generation module 213 may enqueue one or more draw commands into the frame queue 221 while traversing a view hierarchy of parts of each frame. The enqueuing of the commands into the frame queue 221 may not be accompanied by actually drawing their respective frames in a pixel buffer.

The SAM 234 may allocate a pixel buffer in which to enqueue a frame to be displayed. Once the pixel buffer is prepared, the workers 231 through 233 may execute each of the draw commands enqueued in the frame queue 221 together. The workers 231 through 233 may be generated in advance, and may then begin to perform drawing in response to the receipt of a particular signal from the main thread 110. Alternatively, the workers 231 through 233 may be generated in response to the enqueuing of the draw commands in the frame queue 221 by the main thread 110.

The workers 231 through 233 may sequentially withdraw each of the draw commands in the frame queue 221, and may draw different parts of each frame in the pixel buffer. Once the drawing of parts of a frame is complete, the workers 231 through 233 may notify the main thread 110 that their work, i.e., drawing, is complete.

The main thread 110 may stand by until all the workers 231 through 233 finish drawing. In such an example, the main thread 110 composes a frame on an actual screen based on the frame parts drawn in the pixel buffer. Thereafter, the main thread 110 may flush the frame queue 221, thereby removing a draw command corresponding to the composed frame.

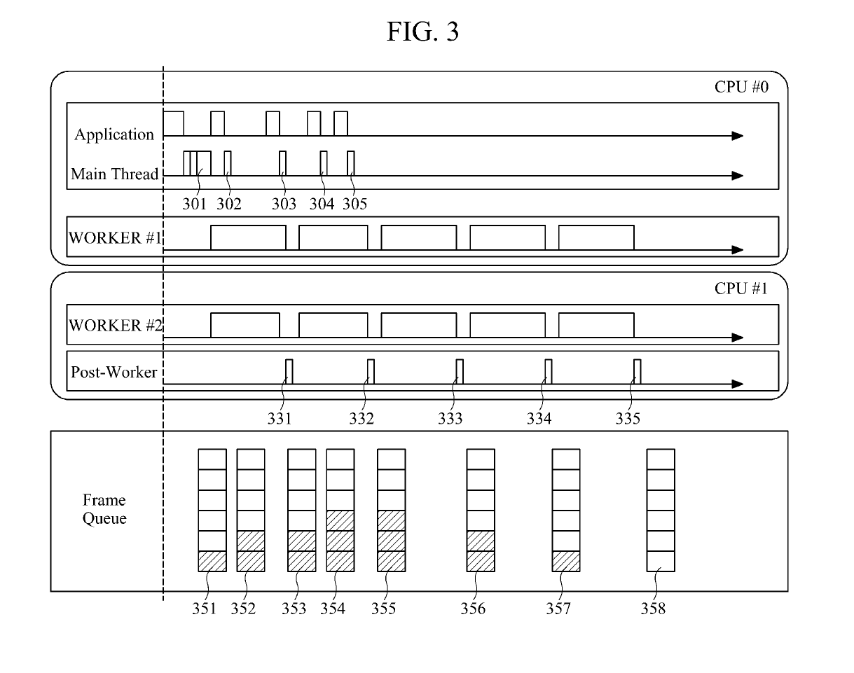

FIG. 3 is a diagram illustrating an operation of an example of a UI framework display system. Referring to FIG. 3, in an example in which an application gives instructions to display a first frame in response to a user event, a main thread may generate a first draw command 301, and may enqueue the first draw command 301, as indicated by reference numeral 351.

In accordance with the first draw command 301, parts of a frame may be divided between, and then drawn by, a plurality of workers, e.g., worker #1 and worker #2. Once the drawing of the parts of the first frame is complete, a frame may be composed based on the drawn frame parts and the composed frame may be displayed on a screen by a post-worker, as indicated by reference numeral 331.

For a particular type of user event, the application may give instructions to display a plurality of frames, e.g., second, third, fourth, and fifth frames, one after another to the main thread. Accordingly, the main thread may generate second, third, fourth, and fifth draw commands 302, 303, 304, and 305 for the second, third, fourth, and fifth frames, respectively. The application may give instructions to draw a frame to the main thread only in response to there being enough space in the frame queue for another draw command. Otherwise, the main thread may stand by until there is enough space in the frame queue for another draw command.

The second, third, fourth, and fifth draw commands 302, 303, 304, and 305 may be enqueued in the frame queue in an order in which their respective frames, i.e., the second, third, fourth, and fifth frames, are to be displayed. For example, the first and second draw commands 301 and 302 may be sequentially enqueued into the frame queue, as indicated by reference numeral 352. In response to the display of the first frame being complete, as indicated by reference numeral 331, the first draw command 301 may be removed from the frame queue, and the third draw command 303, which is next to the draw command 302, may be enqueued into the frame queue, as indicated by reference numeral 353.

The fourth and fifth draw commands 304 and 305 may be executed in the same manner as the first, second, and third draw commands 301, 302 and 303. As a result, the second, third, fourth, and fifth frames may be output one after another, as indicated by reference numerals 332, 333, 334, and 335, and the state in the frame queue varies accordingly, as indicated by reference numerals 354, 355, 356, 357, and 358.

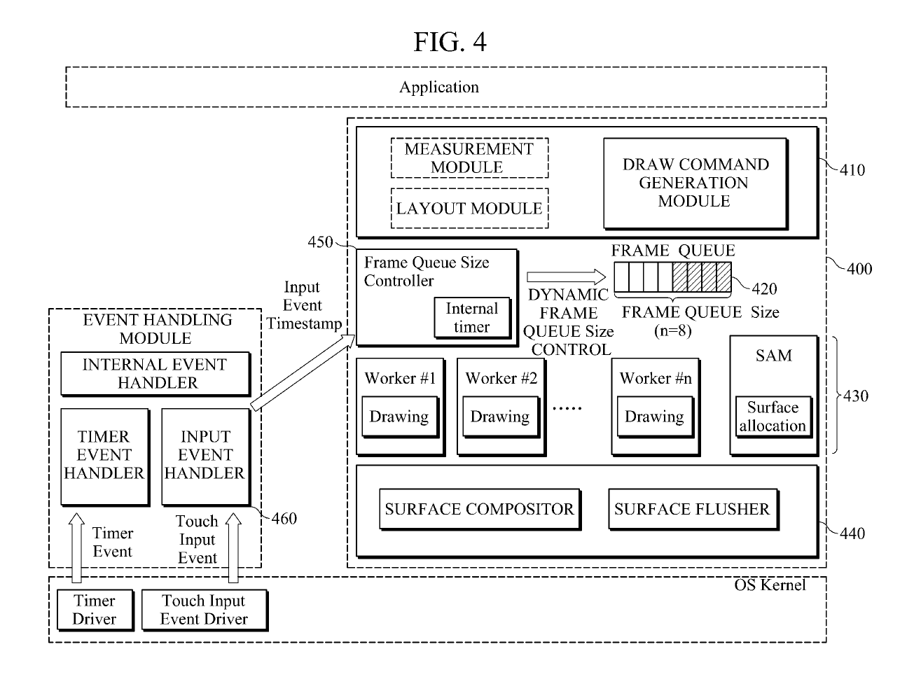

FIG. 4 illustrates an application system including an example of a UI framework display system, which is capable of adjusting the size of a frame queue. Referring to FIG. 4, the application system may include an event handling module, an operating system (OS) kernel, and a UI framework display system 400 that all support the operation of an application.

The UI framework display system 400 may include a main thread 410, a frame queue 420, a frame, a worker thread 430, a post-worker 440, and a frame queue size controller 450.

The main thread 410 may perform measurement and layout processes, if desired, on a new frame, and may enqueue a draw command for the new frame in the frame queue 420.

The size of the frame queue 420 may be initially set to n. For example, in a case in which n=6, the UI framework display system 400 may enqueue up to six draw commands in the frame queue 420.

The main thread 410 may keep enqueuing a draw command in the frame queue 420 until the frame queue 420 is filled up with n draw commands.

The worker thread 430 may include a SAM, which allocates a pixel buffer in which to draw parts of each frame.

More specifically, in an example in which a draw command for a particular frame is enqueued in the frame queue 420 and a pixel buffer for the particular frame is prepared, the SAM may divide parts of the particular frame between a plurality of first through n-th workers (i.e., workers #1 through #n) and may allow the first through n-th workers to draw their respective parts of the particular frame. In response to the drawing of the parts of the particular frame by workers #1 through #n being complete, the drawn frame parts may be enqueued into the pixel buffer.

The post-worker 440 may compose a frame based on the frame parts enqueued in the frame queue 420, and may display the composed frame on an actual screen. Thereafter, the post-worker 440 may perform a surface flush by removing the draw command for the particular frame from the frame queue 420.

The OS kernel may include one or more drivers which receive information from an external device, and may make the received information available for the application. For example, the OS kernel may include a timer driver, which processes time information, and a touch input event driver, which processes a user input (such as a key, mouse, touch input, etc.) received from an input device such as a touchpad, a mouse, a keyboard, or the like.

The event handling module may include an input event handler 460. The input event handler 460 may receive a user event from the OS kernel, may convert the received user event into an event that can be processed by a UI framework, and may provide user event information corresponding to the received user event to the application. In response to a user event occurring, the input event handler 460 may transmit user event information corresponding to the user event and an input event timestamp such as the time of the occurrence of the user event to the frame queue size controller 450.

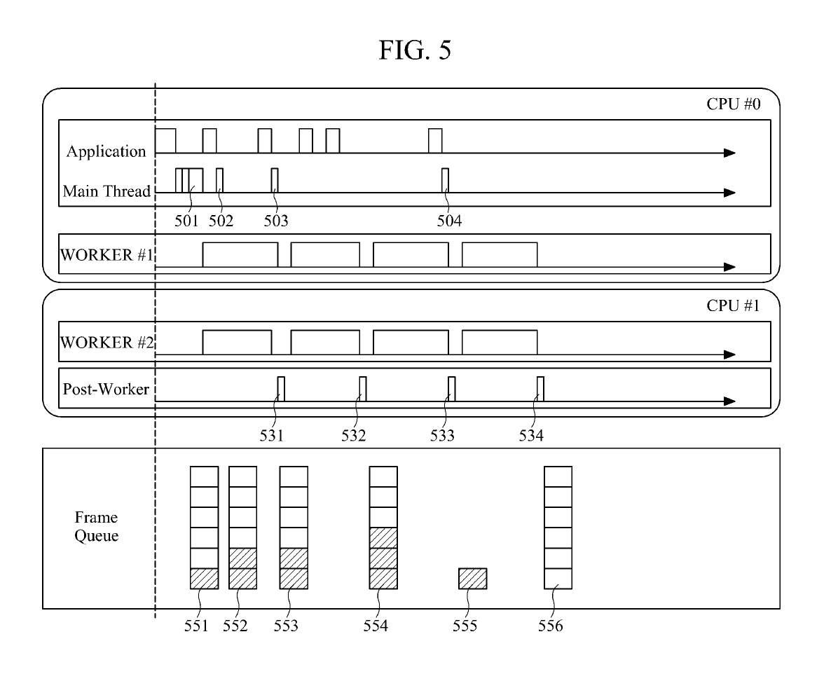

FIG. 5 illustrates an operation of another example of a UI framework display system. Referring to FIG. 5, in an example in which an application gives instructions to display a first frame in response to the occurrence of a user event, a main thread may generate a first draw command 501 for the first frame, and may enqueue the first draw command 501 in a frame queue, as indicated by reference numeral 551.

In accordance with the first draw command 501, parts of the first frame may be divided between and drawn by a plurality of workers (e.g., workers #1 and #2). Once the drawing of the parts of the first frame is complete, a frame may be composed based on the drawn frame parts and the composed frame may be displayed on a screen by a post-worker, as indicated by reference numeral 531.

For particular types of user events, the application may give instructions to display a plurality of frames, e.g., second and third frames, one after another to the main thread. Accordingly, the main thread may generate second and third draw commands 502 and 503 for the second and third frames, respectively. The application may give instructions to draw a frame to the main thread only in response to there being enough space in the frame queue for another draw command. Otherwise, the main thread may stand by until there is enough space in the frame queue for another draw command.

The second and third draw commands 502 and 503 may be enqueued in the frame queue in an order in which their respective frames, i.e., the second and third frames, are to be displayed. For example, the first and second draw commands 501 and 502 may be sequentially enqueued into the frame queue, as indicated by reference numeral 552. Accordingly, in response to the display of the first frame being complete, as indicated by reference numeral 531, the first draw command 501 may be removed from the frame queue, and the third draw command 503, which is next to the draw command 502, may be enqueued into the frame queue, as indicated by reference numeral 553.

Similarly, in response to the processing of the second frame by workers #1 and #2 being complete, the second frame may be displayed by the post-worker, as indicated by reference numeral 532, and the second draw command 502 may be removed from the frame queue, as indicated by reference numeral 554.

If a user event occurs after the receipt of the third draw command 503, the size of the frame queue may be adjusted in accordance with the type of the user event, as indicated by reference numeral 555, in order to improve the responsiveness of the UI framework display system to the user event.

More specifically, in an example in which the application gives instructions to display a frame in connection with the user event, the main thread may generate a fourth draw command 504, and may enqueue the fourth draw command 504 in the frame queue. Thereafter, the main thread may reduce the size of the frame queue in consideration of the characteristics of the user event.

In order to reduce the size of the frame queue, the frame queue may be emptied first by removing all draw commands in the frame queue.

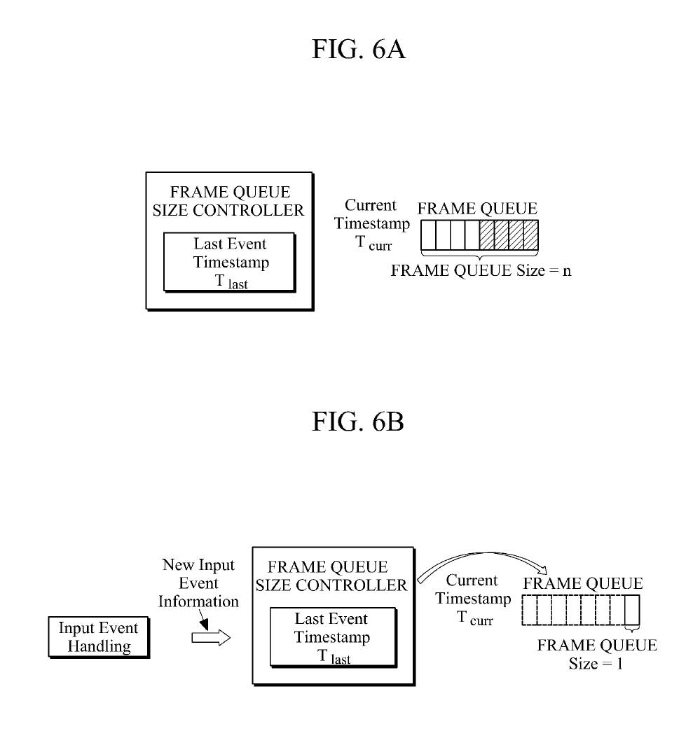

FIGS. 6A and 6B illustrate an example of how to reduce the size of a frame queue. Referring to FIGS. 6A and 6B, it is assumed that a UI framework display system has a frame queue whose size is initially set to n, and increases throughput to provide, for example, an animation effect through consecutive UI processing, such as performed, for example, in elastic scrolling or PhotoSlide.

A frame queue size controller may keep receiving user event information, if any, from an input event handler, and may memorize a time Tₗₐₛₜ of the occurrence of a most-recent user event. Thereafter, the frame queue size controller may determine whether a gap d between a current time T_{curr} and the time Tₗₐₛₜ is less than a threshold time Tₜₕ. The threshold time Tₜₕ may be set in consideration of the direction of the operation of the UI framework display system. For example, the threshold time Tₜₕ may be set to 30 ms.

If d≦Tₜₕ, i.e., if an amount of time that is less than or equal to the threshold time Tₜₕ has passed since the most-recent user event, the frame queue size controller may determine that the responsiveness of the UI framework display system, instead of the throughput of the UI framework display system, should be improved.

In order to improve the responsiveness of the UI framework display system, the size of the frame queue may be reduced to, for example, 1. Since 0≦p≦n where p indicates a number p of frames enqueued in the frame queue, the size of the frame queue may be reduced to 1 by removing all frames present in the frame queue to empty the frame queue. Once the frame queue is flushed, the size of the frame queue may be reset to 1, as illustrated in FIG. 6B.

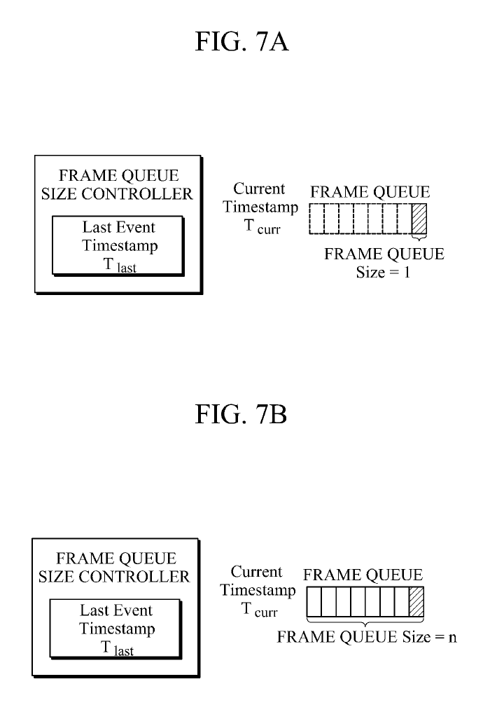

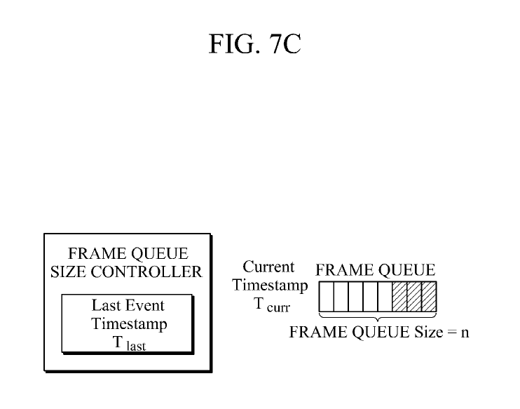

FIGS. 7A through 7C illustrate an example of how to increase the size of a frame queue, and, more particularly, an example of how to return a frame queue reduced to a size of 1 back to its original size of n. Referring to FIG. 7A, a frame queue size controller may keep receiving user event information, if any, from an input event handler, and may memorize a time Tₗₐₛₜ of the occurrence of a most-recent user event. Thereafter, the frame queue size controller may determine whether a gap d between a current time T_{curr} and the time Tₗₐₛₜ is less than a threshold time Tₜₕ.

Referring to FIG. 7B, if d>Tₜₕ, i.e., if an amount of time that is more than the threshold time Tₜₕ has passed since the most-recent user event, the frame queue size controller may increase the size of the frame queue from 1 to n, thereby increasing the throughput of the UI framework display system. More specifically, the frame queue size controller may be configured to increase the size of the frame queue from 1 to n either incrementally or all at once. Afterwards, the UI framework display system may operate with a frame queue size of n, as illustrated in FIG. 7C.

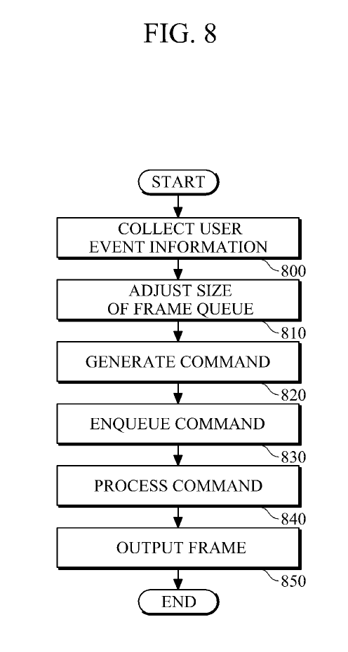

FIG. 8 is a flowchart illustrating an example of a UI framework display system. Referring to FIG. 8, a frame queue size controller may keep receiving user event information, if any (800), and may adjust the size of a frame queue in which to store a draw command for a frame to be displayed in response to the occurrence of a user event (810).

A main thread may receive the frame from an application, and may generate a draw command to divide parts of the frame between a plurality of cores and allow the cores to process their respective parts of the frame (820). Thereafter, the main thread may enqueue the draw command in the frame queue in consideration of when to display the frame (830).

Thereafter, the parts of the frame may be drawn by a plurality of workers in accordance with the draw command enqueued in the frame queue (840). In response to the drawing of all the parts of the frame being complete, the frame may be displayed (850).

In operation 800, the user event information may be provided by an event handling module, which may receive a user event and may provide information on the received user event to the application, and may be different from user event information, if any, provided by the application.

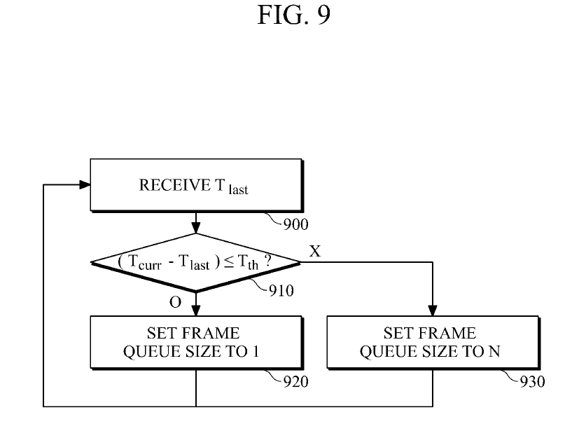

FIG. 9 is a flowchart illustrating another example of a UI framework display system. More particularly, FIG. 9 illustrates an example of operation 810 of FIG. 8. Referring to FIG. 9, a time Tₗₐₛₜ of the occurrence of a most-recent user event may be provided as user event information (900). Thereafter, a gap d between the time Tₗₐₛₜ and a current time T_{curr} may be compared with a threshold time Tₜₕ (910).

If the gap d is less than or equal to the threshold time Tₜₕ, the size of a frame queue may be reduced to 1 (920). On the other hand, if the gap d is greater than the threshold time Tₜₕ, the size of the frame queue may be increased to n (930).

Before the reduction of the size of the frame queue, the frame queue may be emptied by removing all present draw commands, if any, from the frame queue.

The adjustment of the size of the frame queue may be repeatedly performed while continually receiving user event information.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As described above, it is possible to improve general system efficiency by making efficient use of multiple processors in a multi-core environment.

In addition, it is possible to improve the throughput of a UI by increasing the number of frames that can be performed per unit time even for a UI for providing an animation effect, such as, for example, elastic scrolling or PhotoSlide.

Moreover, it is possible to improve the response time of a UI especially in a case of performing, for example, scrolling up or down a list or editing photos using a photo editor application.

Furthermore, it is possible to improve both the throughput and response time of a UI by dynamically adjusting the size of a frame queue.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user interface (UI) framework display system to process a UI framework in a multi-core environment, the UI framework display system comprising:
a main thread configured to receive a frame to be displayed in response to an occurrence of a user event from an application and generate at least one command to allow a plurality of cores to divide the frame therebetween and to process the frame together in parallel;
a queue configured to enqueue the command therein in consideration of when to display the frame;
a worker thread configured to allocate the command to one or more workers and thus to allow the workers to process the command; and
a post-worker configured to output a composed frame obtained by the processing of the command.

2. The UI framework display system of claim 1, wherein the command is a command to divide parts of the frame between the cores and to allow the cores to process their respective parts of the frame in parallel.

3. The UI framework display system of claim 1, wherein the queue is configured to enqueue one or more commands generated for a single frame therein.

4. The UI framework display system of claim 1, wherein the queue is configured to enqueue a plurality of commands generated for different frames therein.

5. The UI framework display system of claim 1, further comprising a queue controller configured to adjust the size of the queue, upon the occurrence of a user event, in accordance with information corresponding to the user event.

6. The UI framework display system of claim 5, wherein the queue controller is further configured to be provided with the information corresponding to the user event from an event handling module, which is provided in the multi-core environment and receives the user event from a user.

7. The UI framework display system of claim 5, wherein the queue controller is further configured to reduce the size of the queue in response to the information corresponding to the user event indicating that a gap between a time of the occurrence of a last previous user event and a current user event is less than a threshold time.

8. The UI framework display system of claim 5, wherein the queue controller is further configured to increase the size of the queue in response to the information corresponding to the user event indicating that a gap between a time of the occurrence of a last previous user event and a current user event is greater than a threshold time.

9. A UI framework display method of processing a UI framework in a multi-core environment, the UI framework display method comprising:
receiving information corresponding to a user event;
adjusting a size of a queue according to the collected information;
receiving a frame to be displayed in connection with the user event from an application and generating a command to divide parts of the frame between a plurality of cores and allow the cores to process their respective parts of the frame in parallel;
enqueuing the command in the queue in consideration of when to display the frame;
allocating the command to workers of the cores and allowing the workers to process the command; and
outputting a composed frame obtained by the processing of the command.

10. The UI framework display method of claim 9, wherein the receiving the information comprises receiving the information from an event handling module, which is provided in the multi-core environment and receives the user event from a user.

11. The UI framework display method of claim 9, wherein the adjusting the size of the queue comprises:
is receiving a time of the occurrence of the user event as the information;
comparing a gap between a time of the occurrence of a last previous user event and a current user event with a threshold time; and
reducing the size of the queue in response to the gap being less than the threshold time.

12. The UI framework display method of claim 11, wherein the adjusting the size of the queue further comprises:
increasing the size of the queue in response to the gap being greater than the threshold time.

13. The UI framework display method of claim 11, wherein the reducing the size of the queue comprises emptying the frame queue by removing one or more commands in the frame queue.

14. A method of displaying a UI framework in a multi-core environment, the method comprising:
receiving information regarding a frame to be displayed;
causing a plurality of cores to each process portions of the frame in parallel; and
outputting a composed frame obtained by the processing by the cores.

15. The method of claim 14, further comprising allocating the portions of the frame to one or more workers provided in the cores.

16. The method of claim 14, further comprising enqueuing commands corresponding to the portions of the frame in a queue.

17. The method of claim 16, further comprising dynamically changing a size of the queue according to timing information corresponding to user events associated with multiple frames.

18. The method of claim 17, wherein the size of the queue is reduced in response to a gap between a last previous user event and a current user event being smaller than a threshold value.

19. The method of claim 17, wherein the size of the queue is increased in response to a gap between a last previous user event and a current user event being larger than a threshold value.

20. The method of claim 18, wherein the reducing the size of the queue comprises emptying the queue by removing one or more commands in the queue.
